(19) United States
(12) Patent Application Publication
(10) Pub. No.: US 2018/0050468 A1
(43) Pub. Date: Feb. 22, 2018

(54) TOOLHOLDER GUIDE SYSTEM IN MANUAL CERAMIC CUTTERS

(71) Applicant: GERMANS BOADA, S.A., RUBI (Barcelona) (ES)

(72) Inventor: Jordi SOLER BALCELLS, RUBI (Barcelona) (ES)

(73) Assignee: GERMANS BOADA, S.A., RUBI (Barcelona) (ES)

(21) Appl. No.: 15/559,717

(22) PCT Filed: Feb. 17, 2016
(86) PCT No.: PCT/ES2016/070096

§ 371 Date: Sep. 19, 2017

(30) Foreign Application Priority Data
Mar. 20, 2015 (ES) P201500223

(51) Int. Cl. B28D 1/22; B28D 7/00

(52) U.S. Cl. CPC B28D 1/22; B28D 7/00

(57) ABSTRACT

A toolholder guide system in manual ceramic cutters, including parallel guides for the longitudinal movement of a toolholder that has a handle for the actuation thereof and carries a cutting tool for scoring a ceramic part. The guides are formed by a profile, for example made of aluminium, each guide having upper and lower steel rods, disposed longitudinally, forming races for bearing carriages disposed on the sides of the toolholder. Each bearing carriage has two end bearings disposed at the same height and at least one intermediate bearing disposed at a lower height than the two end bearings.

### OBJECT OF THE INVENTION

The object of the present invention is a toolholder guide system in manual ceramic cutters that has characteristics intended to gently move the toolholder and increase resistance to the bending of the guides especially during the cutting and separating operations of the ceramic parts.

### FIELD OF APPLICATION OF THE INVENTION

This invention is applicable to manual ceramic cutters.

### STATE OF THE ART

Currently, manual ceramic cutters having a surface to support the ceramic part to be cut; guides that are parallel to each other and the aforementioned support surface of the ceramic part for the longitudinal movement of a toolholder that comprises a handle for the actuation thereof and that generally carries a cutting tool and a separating tool for the ceramic part scored by the cutting tool, are known in the market.

Currently, the use of two parallel cylindrical bars for guiding the toolholder, said toolholder having cylindrical holes for the through-mounting of said pair of guide bars, is known; however, the forces applied to the toolholder during the operations to cut or score the ceramic part and to separate the same causes the guides to bend and a subsequent loss of accuracy in the cut.

One solution intended to prevent this bending is described in the utility model ES 1071906 U of the same owner of the present invention, in which the cutter, in addition to the aforementioned guide system, consisting of passing the guide bars through the inside of longitudinal holes defined in the toolholder head, comprises lateral extensions in the head, the ends of which are coupled and can be longitudinally moved in first non-bending guides secured to end supports of the base of the cutter.

Although this solution is effective in preventing the guide bars from bending, it entails greater constructive complexity since it practically includes two parallel guide systems, one formed by guide bars and the other formed by non-bending bars, which also increases friction in the movement of the toolholder head.

The owner of the present invention is not aware of the existence of prior art that solves the problem posed in what relates to the bending of the moving guides of the toolholder and the reduction of friction between said elements.

### DESCRIPTION OF THE INVENTION

The toolholder guide system in manual ceramic cutters object of this invention has characteristics intended to solve the problem set forth previously and to improve safety in movement and prevent the deformation of the guides, taking into account that during the cutting and subsequent separation of the ceramic parts, a significant force is applied to the toolholder by means of an actuation handle.

According to the invention, the guides are formed by a profile, preferably made of aluminium, and having a “C” shape, each guide comprising upper and lower steel rods that form races for bearing carriages disposed on the sides of the toolholder.

The aforementioned steel rods allow the contact between the bearings and the guides to essentially occur on a regular basis, which allows the movement of the toolholder to be more precise by having less friction.

In one embodiment of the invention, the aluminium profile forming the guides has a longitudinal cavity in which a steel bar is housed that is intended to reinforce and prevent the bending of the guides, especially those in large manual cutters.

In one embodiment of the invention, each bearing carriage disposed on opposite sides of the toolholder comprises three bearings, two end bearings and one intermediate bearing; the end bearings being aligned at the same height and the intermediate bearing being disposed at a slightly lower height, such that the end bearings come in contact with the steel rods in the upper position in the guides and the intermediate bearing comes in contact with the steel rod in the lower position in the guides; this bearing system prevents possible events that the toolholder could cause once mounted on the guides.

In addition, this arrangement of the bearing carriages prevents the toolholder from moving when a force is exerted on it, in order to then separate the cut ceramic parts.

### DESCRIPTION OF THE FIGURES

As a complement to the description provided herein, and for the purpose of helping to make the characteristics of the invention more readily understandable, the present specification is accompanied by a set of drawings, which, by way of illustration and not limitation, represent the following:

FIG. 1 shows a partial perspective view and cross section of an exemplary embodiment of the toolholder guide system in manual ceramic cutters according to the invention.

FIG. 2 shows an elevation view of the guide system of the previous figure.

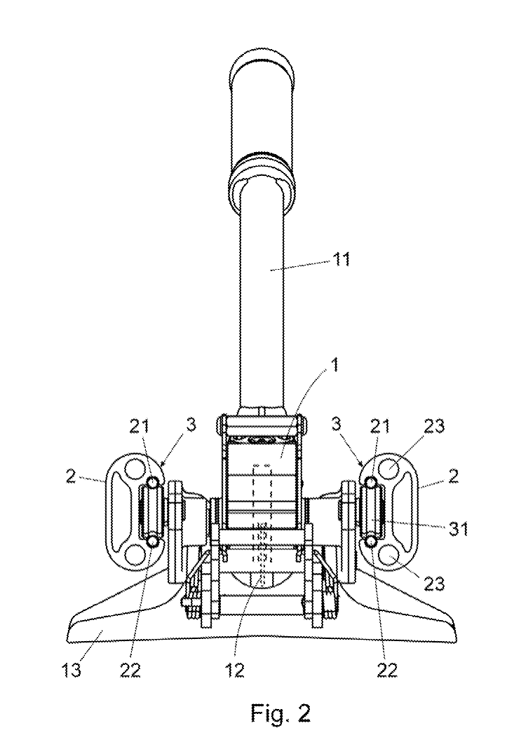

### PREFERRED EMBODIMENT OF THE INVENTION

In the embodiment shown in the attached figures, the toolholder (1) has an actuation handle (11) and, as is common in ceramic cutter machines, it carries a cutting tool (12) and a separator (13) for ceramic parts already scored with the cutting tool.

The toolholder guide system (1) comprises two parallel guides (2) formed by an aluminium profile in a general “C” shape and disposed to face each other, each of the guides (2) comprising a pair of upper and lower steel rods (21, 22), disposed longitudinally and located between wings defined by the aforementioned profile (2); said steel rods (21, 22) forming races for bearing carriages (3) mounted on the sides of the toolholder (1).

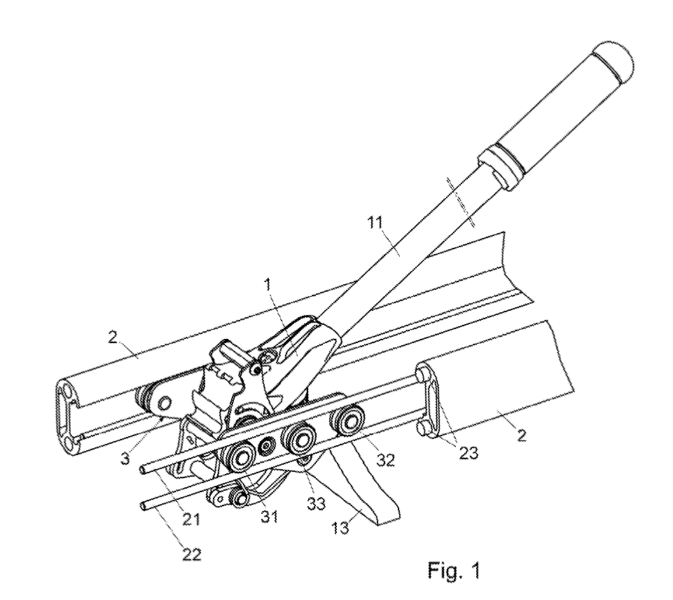

As can be observed in FIG. 1, each bearing carriage (3) comprises two end bearings (31, 32) disposed at the same height and that come in contact with the upper steel rod (21) of the guide (2) corresponding to the same side, and an intermediate bearing (33) disposed at a lower height and that comes in contact with the lower steel rod (22) of the corresponding guide (2).

In the exemplary embodiment shown in the attached figures, the aluminium profile forming the guides (2) incorporates steel bars (23) in the inside thereof in order to increase the resistance to bending of the guides, especially in large cutters.

Having sufficiently described the nature of the invention, in addition to an example of a preferred embodiment, it is hereby stated for the relevant purposes that the materials, shape, size and layout of the described elements may be modified, provided that it does not imply altering the essential characteristics of the invention claimed below.

1-3. (canceled)

4. A toolholder guide system in manual ceramic cutters, comprising parallel guides for longitudinal movement of a toolholder that comprises a handle for the actuation thereof and carries a cutting tool for scoring a ceramic part; wherein the guides are formed by a profile, made of aluminium; each guide comprising upper and lower steel rods, disposed longitudinally, forming races for bearing carriages disposed on the sides of the toolholder; each bearing carriage comprises two end bearings disposed at the same height, which come in contact with the upper steel rod of the guide corresponding to the same side, and at least one intermediate bearing disposed at a lower height than the two end bearings, which comes in contact with the lower steel rod of the corresponding guide.

5. The guide system according to claim 4, wherein the profile forming the guides has an overall “C” shape, the steel rods being disposed between wings defined by said profile.

6. The guide system, according to claim 1, wherein the guides incorporate steel bars with an increased resistance to bending.
